(19) United States
(12) Patent Application Publication
(10) Pub. No.: US 2005/0152281 A1
(43) Pub. Date: Jul. 14, 2005

(54) Secured method for setting up a call connection or a transaction between a terminal and an element of a network infrastructure

(76) Inventors: Jean-Philippe Wary, Bourg La Reine (FR); Paul Wanner, Metz (FR)

Correspondence Address: PERMAN & GREEN, 425 POST ROAD, FAIRFIELD, CT, 06824, US

(21) Appl. No.: 10/980,869

(22) Filed: Nov. 3, 2004

(30) Foreign Application Priority Data
Nov. 6, 2003 (FR) 03 50801

(51) Int. Cl. H04L 12/66; H04L 12/26; H04J 3/14; H04J 1/16; H04L 1/00

(52) U.S. Cl. 370/252

(57) ABSTRACT

To prevent piracy against mobile communications due to the weakening of the A5/2 algorithm, the GMS infrastructure is provided with means to measure the time taken by a telephone to respond to a request (121) for the use of the A5/1 algorithm. If this time is greater (115) than the predetermined period, then it is assumed that there is piracy and the call connection is interrupted.

### BACKGROUND OF THE INVENTION

1. Field of the Invention

An object of the invention is a secured method for setting up a call connection or a transaction between a terminal and an element of a network infrastructure.

The field of the invention is that of telecommunications and, especially that of mobile telephony. Even more particularly, the field of the invention is that of the identification and connection of a terminal to a telecommunications network.

2. Description of the Prior Art

In the prior art, the methods used to detect unlawful deeds at the level of communications or transaction protocols are based on a close examination of the messages received and the rejection of these messages when the parameters that form them do not correspond to the state automatons managed by the call. This prior art method is, for example, implemented in IP “firewalls” for the Internet as well as in ATMs (automatic teller machines) when the requests exchanged between these teller machines and the bank servers do not correspond to the state automatons.

There are new technologies for attacking communications protocols such as the one used by the Technion Institute, Haifa (Instant Cyphertext only Cryptanalysis of GSM encrypted Communication, Barkan-Biham-Keller, August 2003) that are undetectable in the present state of the art. The goal of the present invention is to acquire knowledge of normal behavior and, in the light of this acquired knowledge, reject abnormal requests for connection or for transactions. This heuristic approach, implemented at the level of shape detection or recognition systems, has never been implemented in the securing or protection of communications protocols.

This acquisition of knowledge is achieved by means of a reading of physical measurements specific to identified steps of the protocol. The measurements may, for example, relate to and make use of notions of received or transmitted power, frequency or time periods (or response times). Each of these acquired values is then processed to provide statistical information on behavior that is used to accept or reject a message depending on whether this behavior conforms or does not conform to the statistical values entered.

The acceptance or rejection of the messages therefore then depends on the application of a set of rejection statistics pertaining to the acquired piece of knowledge.

In particular, the GSM protocol uses enciphering algorithms whose security level gets weakened with time. This weakening is due to the increase in the computation power available and the extensive studies published on these algorithms. In particular, time has shown up flaws in one of the symmetrical enciphering algorithms known as A5/2. This algorithm is used especially in the GSM protocol to encipher RF exchanges (between the user and the radio beacon, BTS, of the mobile network).

In fact, the A5/2 algorithm has been breached (see especially in the above-mentioned publication by the Technion Institute Haifa). This means that indiscreet individuals could penetrate the GSM network by usurping an identity when a terminal is connected to this GSM network.

A simple solution to this problem would lie in eliminating the possibility of the use of the A5/2 algorithm by mobile terminals. However, for the GSM, it is estimated that, at present, there are more than 800 million terminals in circulation and it is obviously not possible to consider recalling all or even a significant number of them for modification.

The invention resolves these problems by the analysis, especially in the GSM network, of the frame exchanges between a terminal seeking to link up to the network and the network itself. In particular, the invention studies and scrutinizes the time taken by the terminal to respond to a request from the network, where this request may be one asking for authentication of the network or the request informing the terminal which enciphering algorithms must be used for the remainder of the call connection between said terminal and said network. If this response time goes beyond set boundaries, i.e. if this response time is greater than the response time or response period Δ (or more generally does not correspond to a statistical response period Δ) predetermined by the study of the call connections, then it is deemed that a piracy operation is in progress and the network interrupts the call connection with the terminal liable to be under attack. By convention, the term “response period Δ” or “period Δ” corresponds to all the periods Δi that can be identified in this document. The term “response period Δ” or “period Δ” can also be applied to the case when it corresponds to a set of measurements made on P responses to P messages sent, and the period Δ then has a dimension P (in mathematical terms, it is a vector with a dimension P). The notion “period Δ smaller than or equal to one second” then means, in the multidimensional case, that the set of periods Δ is, for each of these periods, smaller than one second. Similarly, the notion “period Δ smaller than or equal to C seconds”, C being a predetermined real constant, then means in the multidimensional case that the set of the periods Δ is, for each of these periods, smaller than Ci seconds, Ci being a predetermined real constant.

### SUMMARY OF THE INVENTION

An object of the invention therefore is a secured method for setting up a call connection between a terminal and an element of the network infrastructure to which the terminal sends a connection or transaction request, in which:
the terminal sends messages according to the connection or transaction protocol to the element of the network infrastructure,
the element of the network infrastructure responds to these messages according to the connection or transaction protocol,
wherein:
in the course of these exchanges, the element of the network infrastructure acquires P physical measurements on the messages coming from the terminal,
the element of the network infrastructure performs a test of statistical rejection on these P physical measurements relative to previously acquired statistical knowledge and,
should the rejection tests conclude that the terminal has a measured behavior that does not conform to the already acquired knowledge and is therefore abnormal, the element of the network infrastructure rejects the demand for connection or transaction,
whereas, should the test show that the terminal has a measured behavior that conforms to the already acquired knowledge, the element of the network infrastructure extends its knowledge by taking these new measurements into account.

Advantageously, the statistical knowledge is based on a combination of the parameters acquired according to mathematical operators belonging to the group formed at least by addition, subtraction, multiplication and division.

Advantageously, the invention is also characterized in that the rejection test is performed according to one of the statistical characteristics of the functions of distribution of the acquired sample of measurements.

Advantageously, the invention is also characterized in that the rejection test is based on tests of normality.

In an application proper to mobile telephony for combating A5/2 type attacks as defined above, the physical measurement could advantageously be a measurement of a response period. When a mobile telephone makes a connection request:
the telephone sends the infrastructure a first message asking for connection comprising an identifier of the user of the mobile telephone,
the infrastructure responds to the first message by second challenge message comprising a random value,
the telephone responds to the second message by a third message comprising the random value enciphered with a secret key Ki and according to a algorithm known to the infrastructure and the mobile telephone,
the infrastructure responds to the third message, if its contents truly correspond to the use of the key Ki expected by the infrastructure, by a fourth message comprising a designation of an enciphering algorithm to be used for the rest of the communication between the mobile telephone and the infrastructure, a key Kc to be used with the enciphering algorithm being a function of the random factor and of Ki,
the telephone responds to the fourth message, or to a subsequent message from the infrastructure, in using the key Kc and the designated enciphering algorithms,
wherein:
initially, knowledge is acquired of at least one behavioral statistic relating to least one period A of response by a large number of mobile telephones to the P messages of the infrastructure, the infrastructure having knowledge of this time statistic A measures and scrutinizes the response time of the mobile telephone which sends said connection request and applies a rejection test to the response times relative to the knowledge of the statistic Δ which then interrupts the call connection with the mobile telephone if the response to the P messages coming from the infrastructure does not correspond to at least the rejection statistic Δ.

Advantageously, this statistic Δ can be based on a combination of the acquired parameters.

Advantageously, the invention is also characterized by the fact that the periods Δ are equal to one second.

Advantageously, the invention is also characterized by the fact that the rejection tests are based on tests of normality (normal law or Gaussian law) relative to the estimators of the mean and of the standard deviation.

Advantageously, the invention is also characterized by the fact that the mean and the standard deviation are computed on the sample of the N last periods of response to the fourth message, N ranging from 10 to 10,000.

Advantageously, the invention is also characterized by the fact that the magnitude of N is in the range of the hundreds.

Advantageously, the invention is also characterized by the fact that the magnitude of N is in the range of the thousands.

Advantageously, the invention is also characterized by the fact that the magnitude of N is in the range of the tens of thousands.

Advantageously, the invention is also characterized by the fact that a period Δ is never greater than one second.

Advantageously, the invention is also characterized by the fact that the mean and the standard deviation are computed as a predetermined frequency.

This test of rejection of the call connection, i.e. the detection of abnormal behavior leading to a suspicion of unlawful action may be based on a ‘chi-square’ test, a quantile value, a Fisher test, a Student test, a parametrical test—and of course this list is not exhaustive.

Advantageously, the invention is also characterized by the fact that the infrastructure element measuring the period Δ is the base station to which the mobile telephone is connected.

Advantageously, the invention is also characterized by the fact that the infrastructure element measuring the period Δ is the network element coming into play in the setting up of an access or call connection with the mobile network.

Advantageously, the invention is also characterized by the fact that all the messages exchanged between the mobile telephone and the network, whatever the protocol layer or the protocol used, may be the object of a measurement of a response period and the setting up of a statistic on the rejection of the call connection.

### BRIEF DESCRIPTION OF THE DRAWINGS

The invention will be understood more clearly from the following description and the accompanying figures. These figures are given purely by way of an indication and in no way restrict the scope of the invention. Of these figures:

FIG. 1 illustrates steps of the method according to the invention and apparatuses that implement them,

FIG. 2 illustrates a mode of determining the tolerated time of response to a message specifying an enciphering algorithm to be used. (Of course, this example shown, which is based on a Gaussian type of distribution of the response times, in no way restricts the scope of the invention).

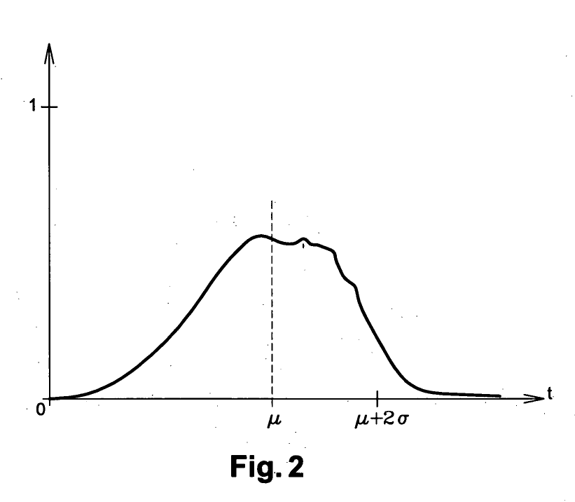

### MORE DETAILED DESCRIPTION

For reasons of simplicity, clarity and concision, the description pertains to the measuring of the period of time Δ between the sending of the fourth message and the reception of its response. However, the same-principle can be applied, for example, to measuring the period Δ between the sending of the second message and the associated response or any other message and its associated response.

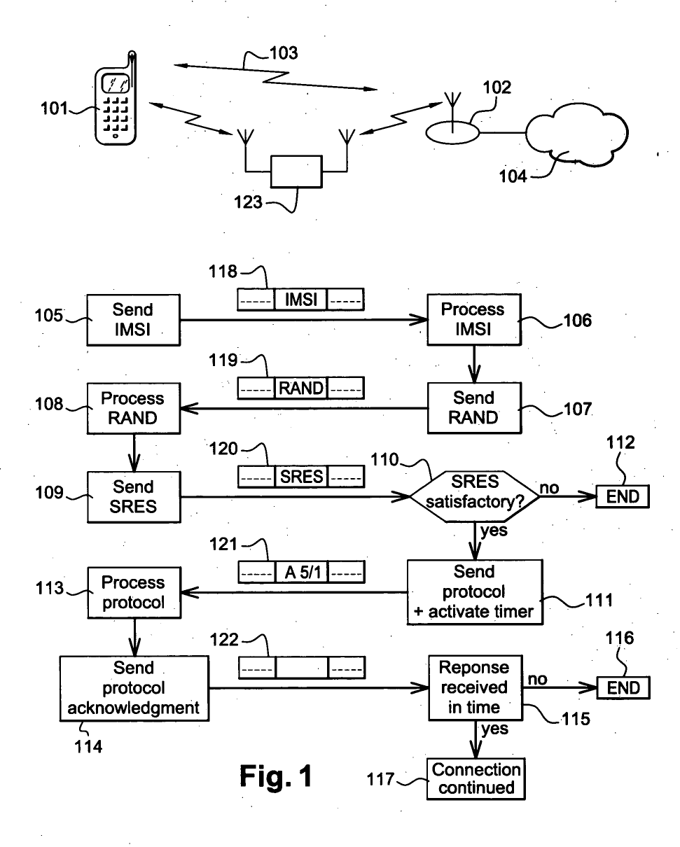

FIG. 1 shows a mobile telephone 101 connected to a base station 102 of the infrastructure of a GSM network 104 by means of a wireless link 103. In practice the base station 102 is connected by a wire network or any other connection means to the rest of the infrastructure of the GSM network. This infrastructure comprises at least the BSC (Base Station Controller) and the MSC (Mobile services Switching Center) on which the base station 102 depends. In a preferred embodiment, the steps of the invention implemented by the infrastructure are actually implemented by one of the previously cited elements of the GSM infrastructure. In practice, any element whatsoever of the infrastructure of the network to which the telephone 101 is connected can implement the steps.

In this description, the actions are attributed to apparatuses such as a mobile telephone, a base station, a BSC, or the like. In practice, for a given apparatus, these actions are performed by a microprocessor of this apparatus. Said microprocessor is controlled by instruction codes recorded in the memory of said apparatus, and the communications take place through connection interfaces of said apparatus.

The present example considers an implementation in a GSM architecture. In practice, the teaching of the invention can be adapted to any communications network architecture for which the network connection protocols have the same weaknesses as the GSM network.

In the following description, no distinction is made between the base station 102 and the infrastructure of the GSM network to which the telephone 101 is trying to get connected.

FIG. 1 shows a step 105 implemented by the terminal 101 during an attempt by this terminal to get connected to the network 104. In the step 105, the terminal 101 sends message asking for connection. This is a first message 118. This connection message is sent to the infrastructure 102. This message asking for connection comprises at least one identifier of the terminal and/or the person using the terminal 101. In practice, this identifier is the IMSI (International Mobile Subscriber Identity) number or the TMSI (Temporary Mobile Subscriber Identity).

From the step 105, the method passes to a processing step 106 in which the infrastructure 102 processes the first message. During this processing step, the infrastructure 102 uses the IMSI number (or the TMSI) for the retrieval, in the infrastructure, of pieces of information associated with this IMSI number. These pieces of information include a key Ki stored within the AUC (Authentication Center). The key Ki is a binary word proper to the IMSI identifier and therefore to the user using the telephone 1012 to get connected with the network 104. This key Ki is also recorded in the user's SIM card in the same way as the IMSI number. The telephone 101 therefore has access to the IMSI number as well as to an authentication request using the Ki key confined within the SIM card.

In practice, the network computes triplets (RAND, SRES, Kc) in advance in order to optimize the exchanges. The network therefore uses one of the available triplets to carry out the authentication step (107, 108, 109 and 110).

Once the subscriber has been identified through his IMSI, the infrastructure produces a pseudo-random binary word RAND.

From the step 106, the method passes to a step 107 in which the infrastructure 102 sends a message of response to the first message. This response is a second message 119. The second message has at least the binary word RAND produced at the step 106. This second message is also called a challenge message. Indeed, there is only one right response to this second message and only the user associated with the IMSI number possesses the SIM card containing the information through which this right response can be produced. In other words, only one apparatus is capable of successfully meeting the challenge by producing the right response.

From the step 107 the method passes to a step 108 in which the second message is processed by the telephone 101. In the step 108, the telephone uses the authentication function of the SIM by submitting to it the RAND value received by the telephone 101 prior to the step 108. The SIM card in the telephone 101 then applies the enciphering algorithm A8 to the binary word RAND contained in the second message by using Ki as an enciphering key to produce a binary word SRES. We therefore have
SRES=A8(RAND, Ki)

For the sake of optimization, the SIM card generally computes the RF communication enciphering key (Kc) at the same time as it computes SRES. This enciphering key is obtained by enciphering the binary word RAND with the key Ki according to the algorithm A3. We therefore have:
Kc=A3(RAND, Ki)

These procedures for the production of the word SRES and the key Kc form part of the GSM protocol. It is therefore normal that they should be known to the SIM card present in the terminal 101. For the same reason, this procedure is also known to the infrastructure 102.

The step 108 is followed by a step 109 for sending the binary word SRES. In the step 109, the SIM card informs the telephone 101 of the value SRES produced. The telephone sends this value of SRES it to the infrastructure 102 in a third message 120 which is a response to the second message. The third message has at least the binary word SRES.

The step 109 is followed by a step 110 for the validation of the third message by the infrastructure 102. The infrastructure 102 indeed knows the binary word RAND, as well as the key Ki and the procedure for the production of the binary word SRES. The infrastructure 102 too is therefore capable of producing the binary word SRES. The infrastructure 102 is therefore capable of ascertaining that the binary word SRES received through the third message truly corresponds to the enciphering of the binary word RAND by the key Ki in using the enciphering algorithm A8. Since only the infrastructure and the telephone 101, through its SIM card, know the key Ki, this procedure enables the sure authentication of the SIM card contained in the telephone 101 and therefore of its user.

In the step 110, if the binary word SRES received through the third message is truly the word expected by the infrastructure 102, then the method passes to a step 111 for sending communications parameters. For example, in the context of the performance of a test to reject communication during the time that elapses between the sending of the second message and the associated response, the measurements of response periods and the rejection test could be performed before the step 111. If the binary word SRES received is not the right one, the method passes to an end step 112 in which the infrastructure 102 interrupts the call connection with the telephone 101.

In the step 111, the infrastructure 102 produces and sends the telephone 101 a fourth message 121 for configuring the call connection. The fourth message comprises at least the designation of an enciphering algorithm. In practice, this is generally the algorithm A5/1 which is known for its robustness. The algorithm A5/1 is a symmetrical algorithm.

From the step 111, the method passes to a step 113 for processing the fourth message. In the step 113, the invention produces a fifth message for taking account of the demand for the activation of the enciphering. The content of this fifth message 122 and of all the following messages is enciphered with the algorithm designated in the fourth message. The enciphering key used is the key Kc.

Once produced, the fifth message is sent in a step 114, to the infrastructure 102 which receives and processes it in a step 115.

In parallel, the telephone sends messages comprising various measurements that it has made on its electromagnetic environment and/or its operating parameters (SACCH messages for example). The content of this sixth message 124 and of all the following messages is enciphered as soon as the fifth message has been sent.

Since the infrastructure 102 knows the word RAND, the key Ki and the procedure for producing Kc, it is capable of producing Kc, deciphering the messages sent by the telephone 101 from the step 114 onwards and sending enciphered messages by using the key Kc.

The key Kc is the key of the session that has just been opened between the telephone 101 and the infrastructure 102. The key Kc is used throughout the session to encipher the content of the messages exchanged between the telephone 101 and the infrastructure 102. The session ends when the connection between the telephone 101 and the architecture 102 is interrupted for any reason whatsoever.

It is known that the GSM protocol stipulates that the algorithm designated in the fourth message can also be the symmetrical algorithm A5/2.

In theory, it is therefore possible for an indiscreet person to have placed an apparatus 123, between the telephone 101 and the infrastructure 102, this apparatus 123 passing itself off, on the one hand, as the infrastructure 102 and, on the other hand, as the telephone 101. In other words, the apparatus 123 then serves as an intermediary between the telephone 101 and the infrastructure 102. The apparatus 123 is totally passive up to the step 111, and only acts as a relay between the telephone 101 and the infrastructure 102. This enables it to obtain knowledge the IMSI, the binary word RAND and the binary word SRES. The apparatus 123, however, modifies the message 121 so that this message designates the algorithm A5/2. In this case, the telephone 101 receiving the fourth message thus modified will continue the call connection in using the algorithm A5/2. In particular, its response to the fourth message will be enciphered by using A5/2. The apparatus 123 will then use the weaknesses of the code A5/2 to decipher the fifth or sixth messages and thus obtain the key Kc and the content of the fifth message. In knowing Kc, the apparatus 123 obtains de facto connection with the network 104 having usurped the identity of the user of the telephone 101. From this point in time onwards, the user of the apparatus 123 can either divert the call as he wishes or simply spy on the call being made by the telephone 101. It is therefore the apparatus 123 that response to the fourth message and does so as it wishes.

In the invention, and in this example, in the step 111, the infrastructure 102 activates a timer when it sends the fourth message. In the step 115, the infrastructure 102 receives a response to the fourth message. Upon reception of this response, the infrastructure stops the timer activated at the step 111. This makes it possible to know the time taken by the telephone 101 to respond to the fourth message. If this measured period is greater than a predetermined period Δ, then the infrastructure 102 interrupts the call connection with the telephone 101 and the method passes from the step 115 to a step 116 of interruption of the connection. If not, the method passes from the step 115 to a step 117 in which the call connection with the telephone 101 is continued.

This is truly a rejection test because, if the fifth message does not arrive within the expected time, it is quite simply rejected. This is called a “statistical rejection” because the decision to reject or not reject depends on a statistic.

This mode of proceeding is relevant because, although the algorithm A5/2 is weakened, the attack against it requires a certain number of enciphered messages to retrieve the enciphering key. In the description of the attack, the enciphered messages are the SACCH frames. Two of these frames are necessary to rebuild the Kc key. However, these frames, owing to the construction of the GSM network radio transmission system, are separated by 480 milliseconds. There is therefore a minimum period of 480 milliseconds added to the normal response time, and this does not include the computation time needed to extract the value of the key. This certain period of time substantially lengthens the apparent time taken by the telephone 101 to respond to the fourth message. An excessively lengthy time of response to this fourth message then corresponds to a possible case of piracy and the call connection has to be interrupted.

The value of Δ can be chosen arbitrarily: for example it may be 1 or 2 seconds, with the usual mean response time being known.

The value of Δ can also be adapted to the environment of the base station 102. For example the infrastructure 102, is capable, for a base station, a BSC or an MSC, of computing a mean time of response to the fourth message. This mean value is calculated, for example, on the N last successful attempts of connection of a telephone to the base station 102, or the BSC on which it depends or the MSC on which it depends. In practice, N ranges from 10 to 1,000. If we have the necessary computation power, it is possible to take N to 10,000 or more.

With knowledge of the mean value μ, it is then possible to define the tolerance relative to this mean value, for example Δ=μ+1 second.

Another variant also entails a computation of the standard deviation a for the N last successful connection attempts. The value of Δ is then chosen to be equal to 2μ plus at least twice σ (or even 3 times σ). This value 2σ or even 3σ gives a probability of mistaken rejection below 1% in the context of a Gaussian law. In this variant, it may also be decided that Δ should never be greater than 1 second. In this case Δ=max (μ+2. σ, 1).

So as not to excessively overload the infrastructure 102 with computing operations, it is also possible to compute the mean and the standard deviation at only a certain frequency, for example at every N successful connection attempts.

In another variant, the variable d is multidimensional and corresponds' to P measurements of times taken to respond to P distinct messages sent by the infrastructure of the network. The rejection statistic can then be built on the basis of theoretical knowledge of the distribution functions of the response periods measured as well as on statistical estimators of these periods. This statistical test is thus built on an assumption of rejection of the probability of occurrence of the measured vector.

To make these computations, for the N last successful connection attempts (N times P measured in the multidimensional context), the infrastructure 102 must keep in memory the time taken to obtain a response to the fourth message. This memory is updated at each new successful connection attempt. This is called acquisition of knowledge or acquisition of a measurement sample. The infrastructure 102 therefore comprises a memory enabling these computations. The infrastructure 102 also has a clock to measure the times of response to the fourth messages.

In another variant, the rejection test is based on a test of normality (relative to a Gaussian or standard law).

A connection is successful if the test at the step 115 according to the invention has taken place successfully. If the number of successful connections is too small, the infrastructure arbitrarily increases Δ. This takes place, for example, if at least 50% of the connection attempts, among the N last attempts, have been unsuccessful.

In one variant of the invention, the time base used for the timing operations is not expressed in seconds, but is computed from the frequency of the quartz crystal controlling the microprocessors or is computed from any other repetitive time pattern of the element of the GSM network responsible for computing the time limits.

In another variant of the invention, the time limits are evaluated on several distinct network elements (for example, BTS, BSC and MSC) and the rejection tests are computed from the collection of the different response periods corresponding to a same call connection (or the setting up of a call connection).

In a preferred variant, the element of the infrastructure making the measurements of the response periods is the base station to which the telephone 101 is connected. Indeed, this variant gives the optimum picture of the electromagnetic environment of the telephone 101, especially as regards propagation.

It may be recalled here that the present invention as described here above can advantageously be transposed to any pile of protocols (IP, Frame Relay, X25, etc.) and any type of transaction (electronic transactions, electronic signature systems, EDI, etc.).

In one variant of the invention applied to GSM telephony, Δ is considered in fact to be a vector having dimensions P=2, the first dimension corresponding to the period Δ1 of response to the message 119, the second dimension relating to the period Δ2 of response to the message 121. In this variant, the rejection test can then be a standardized linear combination of the periods Δ1 and Δ2 such as Δr=a.(μ(Δ1)+2.σ(Δ1))+b.(μ(Δ2)+2.σ(Δ2)), with a+b=1, and a as the standard deviation, and σ as the mean. In this case, the rejection test relates to Δr. For a given attempted connection, with a time d1 of response to the message 119, and a time d2 of response d2 to the message 121, it is then necessary that a.d1+b.d2 should be smaller than Δr. This requires that the element performing the rejection test should have available statistical knowledge relating to Δ1 and Δ2. Should Δ be considered to be a vector, a large number, of parameters can be introduced into the rejection test. These parameters would be for example other response times to messages, sending power, reception power etc. This list is not exhaustive. Each of these parameters may be combined to produce Δr. Any measurable physical variable such as time, power etc., in the context of the implementation of a call connection between a terminal and the network can be used in an implementation of the invention. A measured physical variable gives a physical measurement which, of course, will be a measurement of this physical variable. By way of simplification, a physical measurement is also simply called a measurement.

1. A secured method for setting up a call connection between a terminal and an infrastructure element of the network to which the terminal sends a connection or transaction request, in which:
the terminal sends messages according to the connection or transaction protocol to the element of the network infrastructure,
the element of the network infrastructure responds to these messages according to the connection or transaction protocol,
wherein:
in the course of these exchanges, the element of the network infrastructure acquires P physical measurements on the messages coming from the terminal,
the element of the network infrastructure performs a test of statistical rejection on these P physical measurements relative to previously acquired statistical knowledge and,
should the rejection test conclude that the terminal has a measured behavior that does not conform to the already acquired knowledge and is therefore abnormal, the element of the network infrastructure rejects the demand for connection or transaction,
whereas, should the test identify the fact that the terminal has a measured behavior that conforms to the already acquired knowledge, the element of the network infrastructure extends its knowledge by taking these new measurements into account.

2. A method according to claim 1 wherein the statistical knowledge is based on a combination of the parameters acquired according to mathematical operators belonging to the group formed at least by addition, subtraction, multiplication and division.

3. A method according to claim 1 wherein the rejection test is based on and performed according to one of the statistical characteristics of the functions of distribution of the acquired sample of measurements.

4. A method according to claim 1 wherein the rejection test is based on tests of normality.

5. A method according to claim 1 wherein a mobile telephone seeks to get connected to or carry out a transaction with an infrastructure of a telecommunications network:
the telephone sends the infrastructure a first message asking for connection, comprising an identifier of the user of the mobile telephone,
the infrastructure responds to the first message by second challenge message comprising a random value,
the telephone responds to the second message by a third message comprising the random value enciphered with a secret key Ki and according to a algorithm known to the infrastructure and the mobile telephone,
the infrastructure responds to the third message, if its contents truly correspond to the use of the key Ki expected by the infrastructure, by a fourth message comprising a designation of an enciphering algorithm to be used for the rest of the communication between the mobile telephone and the infrastructure, a key Kc to be used with the enciphering algorithm being a function of the random factor and of Ki,
the telephone responds to the fourth message, or to a subsequent message from the infrastructure, in using the key Kc and the designated enciphering algorithms,
wherein:
initially, knowledge is acquired of at least one behavioral statistic relating to a period Δ of the response by a large number of mobile telephones to the P messages of the infrastructure, the infrastructure having knowledge of this response period statistic Δ measures and scrutinizes the response time of the mobile telephone which sends said connection request and applies a rejection test to the response times relative to the knowledge of the statistic Δ which then interrupts the call connection with the mobile telephone if the response to the P messages coming from the infrastructure does not correspond to at least the rejection statistic Δ.

6. A method according to claim 5 wherein the statistic Δ may be based on a combination of the acquired parameters.

7. A method according to claim 5 wherein the period Δ is equal to one second and, in the case of a multidimensional period Δ, each of the values Δi is equal to one second.

8. A method according to claim 5 wherein the rejection test is based on tests of normality relative to the estimators of the mean and of the standard deviation.

9. A method according to claim 8 wherein the mean and the standard deviation are computed on the sample of the N last periods of the response to the fourth message, N ranging from 10 to 10,000.

10. A method according to claim 5 wherein the magnitude of N is in the range of the hundreds.

11. A method according to claim 5 wherein the magnitude of N is in the range of the thousands.

12. A method according to claim 5 wherein the magnitude of N is in the range of tens of thousands.

13. A method according to claim 5 wherein a period Δ is never greater than 1 second and, in the case of multidimensional period Δ, each of the values of Δi is never greater than one second.

14. A method according to claim 8 wherein the mean and the standard deviation are computed at a predetermined frequency.

15. A method according to claim 5 wherein a period Δ is never greater than a constant value of C seconds and, in the case of a multidimensional period Δ, each of the values of Δi is never greater than Ci seconds.

16. A method according to claim 5 wherein the infrastructure element measuring the period Δ is the base station to which the mobile telephone is connected.

17. A method according to claim 5 wherein the infrastructure element measuring the period Δ is the network element coming into play in the setting up of an access or call connection with the mobile network.

18. A method according to claim 5 wherein all the messages exchanged between the mobile telephone and the network, whatever the protocol layer or the protocol used, are the object of a measurement of a response period and the setting up of a statistic on the rejection of the call connection.
